(19) United States
(12) Patent Application Publication
(10) Pub. No.: US 2010/0031200 A1
(43) Pub. Date: Feb. 4, 2010

(54) METHOD OF INPUTTING A HAND-DRAWN PATTERN PASSWORD

(75) Inventor: Wen-Chi CHEN, Hsinchu City (TW)

Correspondence Address: Muncy, Geissler, Olds & Lowe, PLLC, P.O. BOX 1364, FAIRFAX, VA, 22038-1364, US

(73) Assignee: ARIMA COMMUNICATIONS CORP.

(21) Appl. No.: 12/182,518

(22) Filed: Jul. 30, 2008

(51) Int. Cl. G06F 3/033

(52) U.S. Cl. 715/863

(57) ABSTRACT

A method of inputting a hand-drawn pattern password includes the steps of providing a plurality of input keys on a touch panel; corresponding each of the input keys to a unique character, numeral, or a symbol; and causing a user to sequentially touch a sequence of some of the input keys on the touch panel to thereby draw a user-remembered pattern password, so that a sequence of characters, numerals, and/or symbols corresponding to the input keys for drawing the pattern password constitutes an effective password and are input.

### FIELD OF THE INVENTION

The present invention relates to a method of inputting a hand-drawn pattern password, and more particularly to a method of inputting a password, in which a user is caused to sequentially touch a sequence of input keys on a touch panel to thereby draw a user-remembered pattern password, and a sequence of characters, numerals, and/or symbols corresponding to the input keys used in drawing the pattern password constitute an effective password being input.

### BACKGROUND OF THE INVENTION

People are now living in an era of information explosion. More and more different kinds of personal electronic products have been developed for the purpose of communication and information exchange. Almost all these electronic products require a personal password for them to start operating, so as to ensure good protection of data stored thereon. For example, mobile phones, personal digital assistants (PDAs), personal computers, financial cards, and various kinds of virtual web worlds all require a personal password for them to function.

In general, a password for an electronic product consists of 4 to 10 or more numerals or characters. The length of the password is certainly in direct proportion to the data protection level. However, when a user has to use more and more personal electronic products, he or she will have to set and remember a large number of passwords for different electronic products. Eventually, these passwords form a burden to the user because they have already exceeded the user's limited capacity of remembering such passwords. As a result, it often takes place that a user forgets or confuses some characters or numerals contained in different passwords and becomes unable to use the electronic products.

There is another problem in connection with the passwords for the electronic products. Conventionally, a password for an electronic product is input via an input interface, such as a keyboard or a touch panel. The touch panel may show, for example, a keyboard-like menu, such as the touch screen on an ATM, a PDA, and a mobile phone. A user has to rely on his or her memory capacity to input via the input interface the characters, numerals and/or symbols that constitute a correct password.

Therefore, it is desirable to develop an effective and easy way of inputting a password to save a user's time and efforts in remembering a large number of passwords for different personal electronic products.

### SUMMARY OF THE INVENTION

It is known that human brain is much more capable of memorizing a pattern than a long string of characters, numerals and symbols. Accordingly, it would be advantageous to convert the conventional way of authenticating a character-based or symbol-based password by inputting a long string of characters, numerals, and/or symbols into a much easier way of just hand-drawing a user-remembered pattern corresponding to a preset pattern password, allowing the user to input a password intuitively. As a result, it would be no longer necessary for a user to remember a long string of characters, numerals and/or symbols that constituting a password. When inputting the hand-drawn pattern password, the user needs only to manually draw a corresponding pattern on a touch panel by sequentially touching a sequence of input keys on the touch panel. Therefore, the user is relieved from the burden of remembering the character-based or symbol-based passwords and able to intuitively input the pattern password. And, the possibility of forgetting a password is minimized and the time being wasted on inputting incorrect password can be saved.

Therefore, it is a primary object of the present invention to provide a method of inputting a hand-drawn pattern password. The method may be implemented on all kinds of touch panel devices, so that a user is allowed to input a password for operating on the touch panel device simply by hand-drawing a user-remembered pattern by touching a sequence of input keys on a touch panel of the touch panel device without the need of remembering and inputting a long string of characters, numerals, and/or symbols.

To achieve the above and other objects, the method of inputting a hand-drawn pattern password according to the present invention includes the steps of providing a plurality of input keys on a touch panel; corresponding each of the input keys to a unique character, numeral, or a symbol that is invisible on the touch panel; causing a user to sequentially touch a sequence of some of the input keys on the touch panel to thereby draw a user-remembered pattern password, so that a sequence of characters, numerals, and/or symbols corresponding to the input keys for drawing the pattern password constitute an effective password and are input; and comparing the input password with a password originally stored in the touch panel device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a touch panel device, via which the method of inputting a hand-drawn pattern password according to the present invention is implemented;

FIG. 2 is a flowchart showing the steps included in the method of inputting a hand-drawn pattern password according to the present invention;

FIG. 3A is a perspective view of an example of a touch panel device for use in the method of the present invention, on a touch panel of which a plurality of input keys is provided;

FIG. 3B shows an array of numerals and symbols invisibly corresponding to the input keys on the touch panel of FIG. 3A;

FIGS. 4A and 4B show a first example of inputting a hand-drawn pattern password according to the method of the present invention; and

FIGS. 5A and 5B show a second example of inputting a hand-drawn pattern password according to the method of the present invention.

### DETAILED DESCRIPTION OF THE PREFERRED EMBODIMENTS

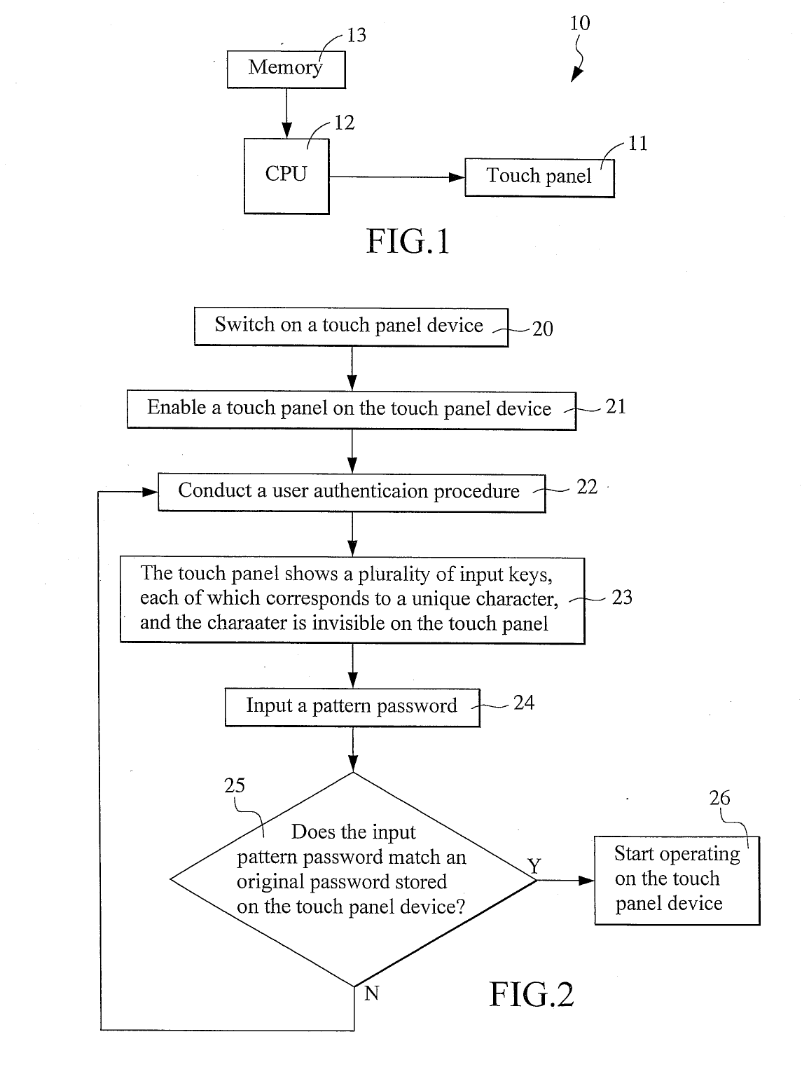

Please refer to FIG. 1, which is a block diagram of a touch panel device 10 via which the method of inputting a hand-drawn pattern password according to the present invention is implemented. As shown, the touch panel device 10 includes a touch panel 11 on which an array of input keys are provided to each invisibly correspond to a unique character, numeral, or symbol; a central processing unit (CPU) 12 for executing all steps of the method of the present invention; and a memory 13 for storing operating programs and other data in connection with the implementation of the method of the present invention.

Please now refer to FIG. 2 that is a flowchart showing the steps included in the method of inputting a hand-drawn pattern password according to the present invention implemented via the touch panel device 10. As shown, the steps include:

Step 20, in which a user switches on the touch panel device 10;

Step 21, in which the touch panel 11 is enabled when the touch panel device 10 is switched on;

Step 22, in which a user authentication procedure is conducted;

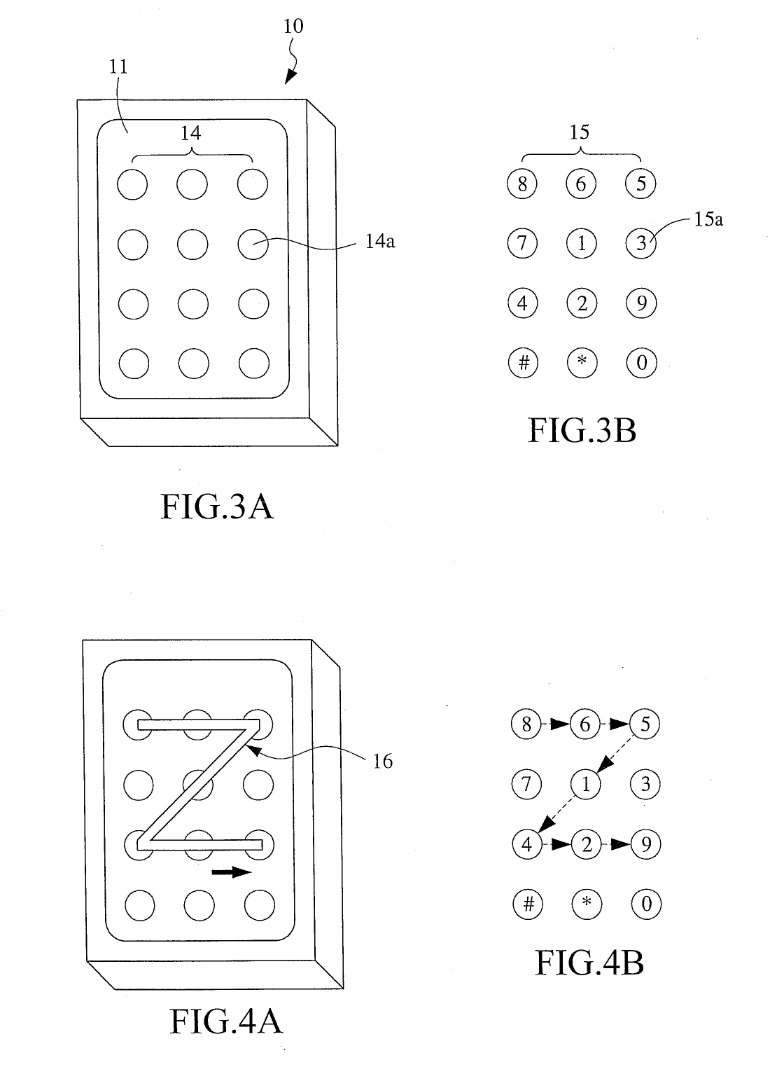

Step 23, in which the touch panel 11 shows an array of input keys 14, such as that shown in FIG. 3A; the array of input keys 14 corresponds to an array of characters, a numerals, and a symbols 15, such as that shown in FIG. 3B, and each of the input keys 14 corresponds to a unique character, a numeral, or a symbol 15. For example, the input key 14a on the touch panel 11 corresponds to the numeral “3” 15a. When the input key 14a is touched, the numeral “3” 15a is triggered and input to the touch panel device 10. It is noted the array of characters, numerals, and symbols 15 are not visible on the touch panel 11;

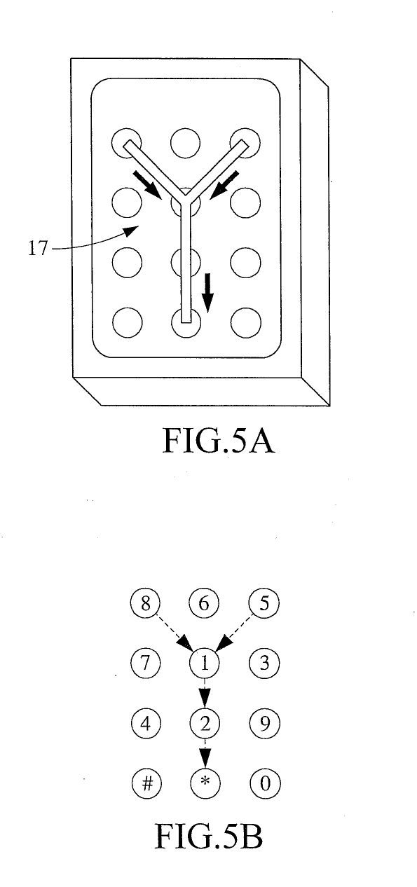

Step 24, in which the user sequentially touches a sequence of input keys 14 on the touch panel 11 to input a hand-drawn pattern password according to a pattern as remembered by the user. For examples, the user may sequentially touch a sequence of input keys 14 on the touch panel 11 to draw a pattern “Z” 16, as that shown in FIG. 4A. In the illustrated example, the hand-drawn pattern “Z” 16 corresponds to a sequence of numerals of “8”, “6”, “5”, “1,” “4”, “2”, and “9”, as that shown in FIG. 4B. That is, the pattern “Z” 16 drawn by the user on the touch panel 11 by touching a sequence of input keys 14 would input an effective password of “8651429”. Or, the user may sequentially touch a sequence of input keys 14 on the touch panel 11 to draw a pattern “Y” 17, as that shown in FIG. 5A. In this example, the hand-drawn pattern “Y” 17 corresponds to a sequence of numerals and symbols of “8”, “1”, “5”, “1”, “2”, and “*”, as that shown in FIG. 5B. That is, the pattern “Y” 17 drawn by the user on the touch panel 11 by touching a sequence of input keys 14 would input an effective password of “81512*”. However, the user could not see and does not know what characters, numerals, or symbols have been input when he or she has hand-drawn a pattern on the touch panel 11 by touching different input keys 14;

Step 25, in which, after a password has been input by the user by hand-drawing a remembered pattern on the touch panel 11, a comparator (not shown) in the CPU 12 receives and compares the input password with a password originally stored in the touch panel device 10. If it is found in the comparison the input password matches the password originally stored in the touch panel device 10, the user authentication is completed, and the method goes to Step 26; and if the input password does not match the originally stored password, the method goes back to the Step 22 or other adequate steps; and

Step 26, in which the user passing the authentication may start operating on the touch panel device 10.

According to the method of the present invention, a user needs only to remember a simple pattern to complete the input of a corresponding password that might be a combination of a plurality of characters, numerals, and/or symbols. Therefore, the conventional way of authenticating a character-based or symbol-based password by inputting a long string of characters, numerals, and/or symbols may be converted into a much easier way of just hand-drawing a user-remembered pattern on a touch panel, allowing the user to input a password intuitively.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of inputting a hand-drawn pattern password via a touch panel, comprising the steps of:
(a) providing an array of input keys on the touch panel;
(b) corresponding each of the input keys to a unique character, numeral, or a symbol; and
(c) a user sequentially touching a sequence of some of the input keys on the touch panel to thereby draw a user-remembered pattern password, so that a sequence of characters, numerals, and/or symbols corresponding to the input keys being used in drawing the pattern password constitute an effective password and are input.

2. The method of inputting a hand-drawn pattern password as claimed in claim 1, wherein the characters, numerals, and symbols corresponding to the input keys are not visible on the touch panel.
